(19) United States
(12) Patent Application Publication
(10) Pub. No.: US 2007/0075962 A1
(43) Pub. Date: Apr. 5, 2007

(54) Electrophoretic display with reduced look-up-table memeory

(75) Inventors: Guofu Zhou, Best (NL); Jan Van De Kamer, Heerlen (NL); Mark T. Johnson, Veldhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/571,804

(22) PCT Filed: Sep. 15, 2004
(86) PCT No.: PCT/IB04/51767

§ 371 Date: Mar. 15, 2006

Related U.S. Application Data
(60) Provisional application No. 60/503,844, filed on Sep. 18, 2003.

(51) Int. Cl. G09G 3/34

(52) U.S. Cl. 345/107

(57) ABSTRACT

An display device (301) has reduced memory (314) requirements for temperature compensation data. A scaling factors (433) for various temperatures and a look-up table for a waveform which is optimized to drive the grayscale for a given display temperature are stored in memory (314). The waveform for a particular temperature of the display (301) is derived from the look-up table and scaling factors (433). At some temperatures, only certain parts of the waveform need be varied, and only these parts require accurate scaling from the look-up table.

The invention relates to a bi-stable display in which display elements are changed from a first to a second display state by application of a potential difference and an apparatus and method for transferring image data to the display.

Display devices of this type are typically electrophoretic displays used, for example, in monitors, laptop computers, personal digital assistants (PDA's), mobile telephones and electronic books, newspapers, magazines, etc.

An electrophoretic display comprises an electrophoretic medium (electronic ink) containing charged particles in a fluid, a plurality of display elements (pixels) arranged in a matrix, first and second electrodes associated with each pixel, and a voltage driver for applying a potential difference to the electrodes of each pixel to cause charged particles to occupy a position between the electrodes, depending on the value and duration of the applied potential difference, so as to display an image or other information.

A display device of the type mentioned in the opening paragraph is, for example, known from international patent application WO 99/53373WO, published Apr. 9, 1999, by E Ink Corporation, Cambridge, Mass., US, and entitled Full Color Reflective Display With Multichromatic Sub-Pixels. That patent application discloses a display comprising two substrates, one of which is transparent. The other substrate is provided with electrodes arranged in rows and columns. A crossing between a row and a column electrode is associated with a display element or pixel. The display element is coupled to the column electrode via a thin-film transistor (TFT), the gate of which is coupled to the row electrode. This arrangement of display elements, TFT transistors and row and column electrodes jointly forms an active matrix. Furthermore, the display element comprises a pixel electrode. A row driver selects a row of display elements and the column driver supplies a data signal to the selected row of display elements via the column electrodes and the TFT transistors. The data signal corresponds to graphic data to be displayed.

Furthermore, electrophoretic ink is provided between the pixel electrode and a common electrode provided on the transparent substrate. The electrophoretic ink comprises multiple microcapsules of about 10 to 50 microns. Each microcapsule comprises positively charged white particles and negatively charged black particles suspended in a fluid. When a negative field is applied to the common electrode, the white particles move to the side of the microcapsule directed to the transparent substrate, and the display element becomes visible to a viewer. Simultaneously, the black particles move to the pixel electrode at the opposite side of the microcapsule where they are hidden from the viewer. By applying a negative field to the pixel electrode, the black particles move to the common electrode at the side of the microcapsule directed to the transparent substrate, and the display element appears dark to a viewer. When the electric field is removed, the display device remains in the acquired state and exhibits a bi-stable character.

Grayscale in the display device images can be generated by controlling the amount of particles that move to the counter electrode at the top of the microcapsules. For example, the energy of the positive or negative electric field, defined as the product of field strength and time of application, controls the amount of particles moving to the top of the microcapsules.

Grayscales in electrophoretic displays are generally created by applying voltage pulses for specified time periods. They are strongly influenced by image history, dwell time, temperature, humidity, lateral inhomogeneity of the electrophoretic foils, etc. To compensate the influence of temperature variations in the display, the sequences of potential differences (also referred to in this application as waveforms) have to be adjusted according to the measured temperatures, e.g. the duration (or “length”) of driving voltage pulse required at higher temperature is shorter for the same grayscale transition when a substantially constant voltage level is used.

Various look-up-tables (LUT's) for different temperatures are usually pre-determined, measured and stored in the display controller itself and in an external memory. The driving waveform is then adjusted using these LUT's according to the measured temperature in the display. The storage of many independent LUT's for various temperatures requires large amounts of memory.

These LUT's are usually derived from temperatures of the display and requirements for compensating the temperature variation in the display during grayscale driving, leading to reproducible grayscales independent of temperature.

A disadvantage is the amount of LUT data that must be stored and accessed for the display. An LUT can consume about 8 kbyte of ROM at a temperature, e.g. 25° C. The temperature range of the display, for example, −20° to 70° C., must be considered. This means a range of 90° C. Usually, it is necessary to compensate the waveform every 2° C. That means storing 90/2=45 LUT's', thus a total of 360 kb of ROM is required. That amount of memory is usually not available inside the controller, so an external (FLASH) ROM is needed, adding cost and using PCB board space.

It is an object of the invention to provide a display in which the memory required for temperature compensation is substantially reduced.

A further object is to provide a display in which the need for memory storage outside the display controller is reduced or eliminated.

Further advantageous embodiments of the present invention are related disclosed below and set forth in the dependent claims.

In the present invention, the waveform that is optimal for a given reference temperature, e.g. 25° C., is scaled for other temperatures. Only a single LUT with scaling factors may be required for an entire temperature range, instead of many independent LUT's for various temperatures, permitting significant savings in cost and in device space.

When the waveform is scaled, only a table list of, e.g., 45 scaling factors need be generated, instead of 45 LUT's. Each factor is only about 1 byte allowing scaling by 1% to 255%. Approximately 8 kbytes of ROM to store the basic, optimal waveform and only a single additional LUT of 45 bytes are required. In total this means that 8×1024 plus 45, i.e. just over 8 kbytes. This amount of (FLASH) ROM is commonly available inside the display controller, saving (in 2003) costs of about $3 and board space of about 3 cm².

These and other aspects of the invention will be apparent from and elucidated with reference to the embodiment(s) described hereinafter.

In the drawings:

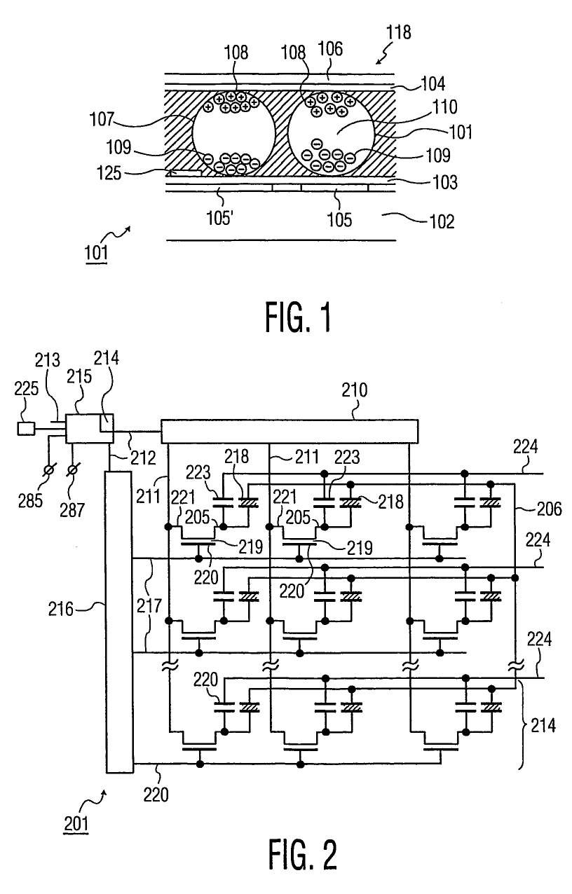

FIG. 1 is a diagrammatic cross-section of a portion of a display device.

FIG. 2 is a circuit diagram of a portion of a display device.

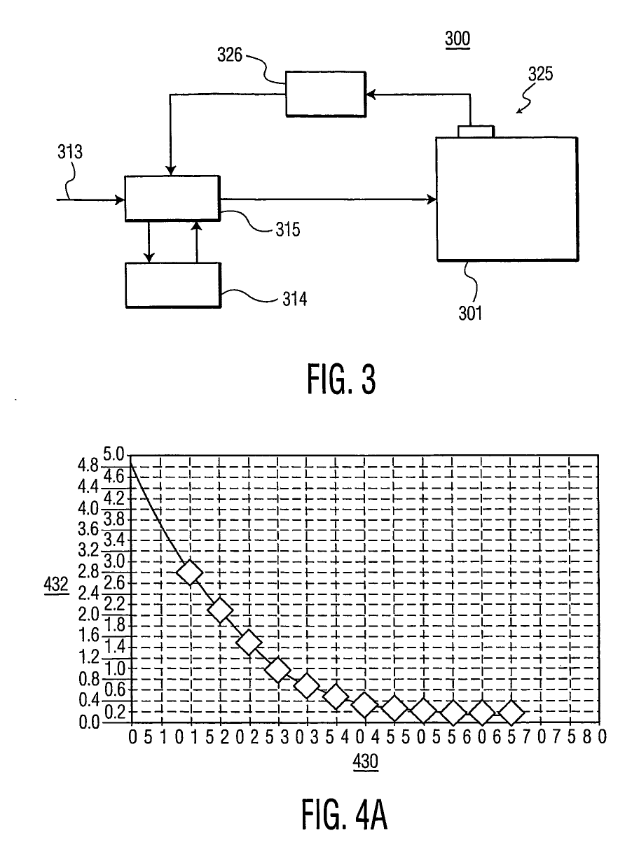

FIG. 3 is a block diagram of an exemplary embodiment of the invention.

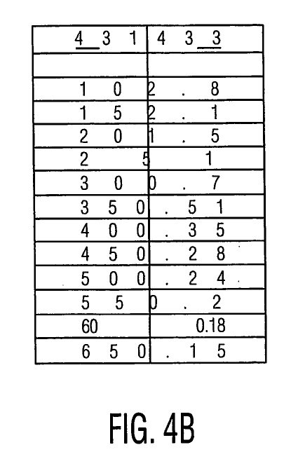

FIG. 4 is a graph of scaling factor vs temperature (° C.) of an exemplary table of scaling factors.

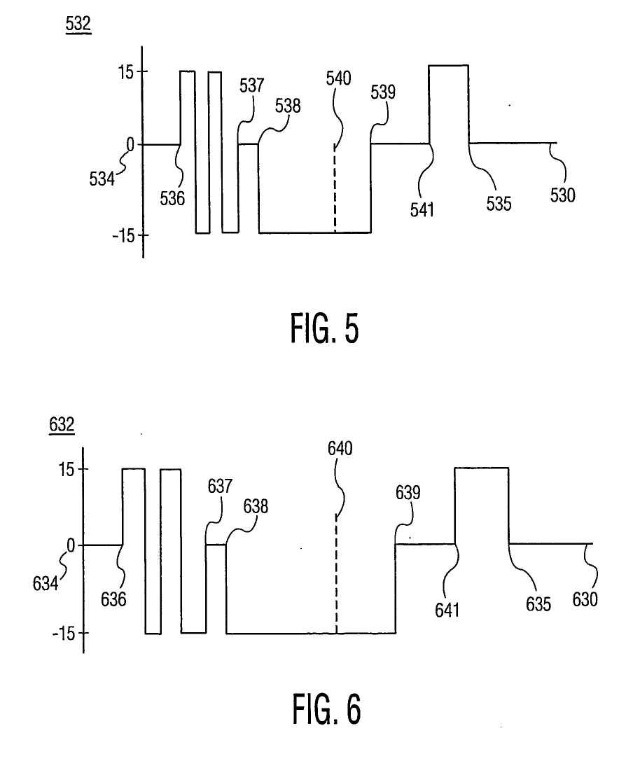

FIG. 5 shows an exemplary drive signal waveform from a look-up table according to the invention.

FIG. 6 shows an exemplary scaled drive signal waveform according to the invention.

Embodiments of the present invention are explained with reference to the attached drawings. The Figures are schematic and not drawn to scale, and, in general, like reference numerals refer to like parts.

FIG. 1 is a diagrammatic cross-section of a portion of an electrophoretic display device 101, for example of the size of a few display elements, comprising a base substrate 102, an electrophoretic film with an electronic ink which is present between two transparent substrates 103, 104 of, for example, polyethylene. One of the substrates 103 is provided with pixel electrodes 105, 105′, which may not be transparent, and the other substrate 104 is provided with a transparent counter electrode 106. In this example, the electronic ink comprises multiple microcapsules 107 of about 10 to 50 microns. Each microcapsule 107 comprises positively charged white electrophoretic particles 108 and negatively charged black electrophoretic particles 109 suspended in a fluid 110. When a positive field is applied to the pixel electrode 105, the white particles 108 move to the side of the microcapsule 107 directed to the pixel electrode 105, and the display element 118, here comprising the counter electrode 106, pixel electrode 105 and microcapsule 107, becomes visible to a viewer. Simultaneously, the black particles 109 move to the opposite side of the microcapsule 107 where they are hidden from the viewer. By applying a negative field to the pixel electrodes 105, the black particles 109 move to the side of the microcapsule 107 directed to the counter electrode 106, and the display element 118 appears dark to a viewer. When the electric field is removed, the particles 108, 109 remain in the acquired state and the display exhibits a bi-stable character and consumes substantially no power.

A temperature sensor 125 measures a temperature indicative of the temperature of the display device 101, in particular of the fluid 110 and the microcapsules 107. The temperature sensor 125 is typically a silicon based sensor such as the LM75A digital temperature sensor from Philips Semiconductors, but may be a thermocouple or other temperature sensing device equipped with a transducer to transmit the temperature measurement in digital form to a controller 215 (shown in FIG. 2).

FIG. 2 is an equivalent circuit diagram of a picture display device 201 comprising an electrophoretic film laminated on a base substrate 102 in (FIG. 1) provided with active switching elements, a row driver 216 and a column driver 210. Preferably, a counter electrode 206 is provided on the film comprising the encapsulated electrophoretic ink, but could be alternatively provided on a base substrate in the case of operation with in-plane electric fields. The display device 201 is driven by active switching elements, in this example thin-film transistors 219. It comprises a matrix of display elements 218 at the area of crossings of row or selection electrodes 217 and column or data electrodes 211. The row driver 216 consecutively selects the row electrodes 217, while a column driver 210 provides a data signal to the column electrode 211. The controller 215 first processes incoming data 213, including input from the temperature sensor 225 into the data signals, in particular, the scaled pulse sequences of the present invention. Counter electrodes may be coupled to two outputs 285, 287 of the controller 215. Mutual synchronization between the column driver 210 and the row driver 216 takes place via drive lines 212. Select signals from the row driver 216 select the pixel electrodes 205 via the thin-film transistors 219 whose gate electrodes 220 are electrically connected to the row electrodes 217 and the source electrodes 221 are electrically connected to the column electrodes 211. A data signal present at the column electrode 211 is transferred to the pixel electrode 205 of the display element coupled to the drain electrode via the TFT. In the embodiment, the display device of FIG. 1 also comprises an additional capacitor 223 at the location of each display element 218. In this embodiment, the additional capacitor 223 is connected to one or more storage capacitor lines 224. Instead of TFT's, other switching elements can be used, such as diodes, MIM's, etc.

FIG. 3 illustrates, in a schematic block diagram, an implementation according to the invention. The drive means 300 comprises a controller 315 for applying potential differences or pulses to the display elements of the display 301 and a memory 314. A temperature sensor 325 and transducer 326, which, respectively, measure and transmit a temperature of the display, are also provided.

The memory 314, which includes, for example, a ROM or RAM, contains an LUT with data for a reference waveform that is optimal for the display 301 at a given, reference temperature of the display. The memory may be present as a separate, external storage device, but may alternatively form part of the controller 315 or of a larger memory or drive system. The memory is programmed in such a way that the reference waveform is passed on to the controller 315, upon demand from the controller 315.

The controller 315 receives image data 313 indicating a desired optical state, from a video processor or similar device (not shown), for the image to be displayed. The controller 315 reads the temperature from the temperature sensor 325 by way of the transducer 326 and reads the reference waveform from the LUT in the memory 314. As the display 301 is addressed for each pixel, the controller 315 correlates the temperature read with the appropriate scaling factor, calculates the scaled waveform and transmits the waveform data pulse to the display.

FIG. 4-A shows an exemplary graph of scaling factors. FIG. 4-B shows the scaling factors in tabular form. The values along the x-axis 430 of the graph and in the first column 431 of the table are temperature in ° C. The values along the y-axis 432 of the graph and in the second column 433 of the table are the scaling. The scaling factors are determined experimentally for a particular display design. The points are measured data. The line on the graph is a curve fitted to the data, y=3E−05x³+0.0045x²−0.2488x+4.886, R²=0.9995. The scaling has been chosen for a sequence of potential differences, which is optimal for a temperature of 25° C. The basic sequence optimal for 25° C. can be scaled for 20°C. with a scaling factor of 150% and for 30° C. with a scaling factor 70%.

It has also, for example, been demonstrated experimentally on other active matrix displays that a basic waveform optimal for 25° C. can be scaled for 20° C. with a scaling factor of 110% and for 30° C. with a scaling factor 90%.

This approach is especially powerful for a temperature range between −20 and 40° C., in which the optical response vs. applied voltage pulse time or voltage curve is almost linear.

FIG. 5 shows a reference sequence of potential differences determined experimentally as optimal for addressing data to a pixel of the display at display temperature of, for example, 25° C. The x-axis 530 is time in seconds. They-axis 532 is voltage with one division equal to 15 Volts. An initial light gray state at starting time 534 of the pixel is switched toward a dark gray state at time t₄ 535 by applying preset potential differences (or shaking pulses) of four preset values, subsequently +15 Volts, −15 Volts, +15 Volts and −15 Volts from time t₀ 536 t′₀ 537. Each preset value is applied for e.g. 20 ms. The time interval between t′₀ 537 and t₁ 538 is negligibly small. Subsequently, the reset potential difference has, e.g., a value of −15 Volts and is present from time t₁ 538 to time t₂ 539. The reset duration (the time from t₁ 538 to t′₂ 540) and the additional (over-) reset duration, from t′₂ 540 to t₂ 539 are e.g. 150 ms and 50 ms, respectively. As a result, the particles 109 occupy an extreme position and the display element has a substantially black appearance. The picture potential difference is present from time t₃ 541 to time t₄ 535 and has a value of e.g. 15 Volts and a duration of e.g. 50 ms. The display element 218 then appears dark gray for displaying the picture.

FIG. 6 shows an exemplary scaled drive signal waveform according to the invention for the display scaling shown in FIG. 4. The measured temperature of the display is chosen as 20° C., which corresponds to a scaling factor of 1.5 read from FIG. 4. The controller 315 reads the reference sequence of potential differences of FIG. 5 from the LUT in the memory 314, correlates the measured temperature of 20° C. with the 1.5 scaling factor from FIG. 4, and calculates the scaled sequence of FIG. 6.

The x-axis 630 in FIG. 6 is time in seconds. The y-axis 632 is voltage with one division equal to 15 Volts. The optical transition is the same as in FIG. 5: an initial light gray state at starting time 634 of the pixel is switched toward a dark gray state at time t₄ 635. In FIG. 6 the scaling factor of 1.5 is applied to increase the period of each preset voltage between time t₀ 636 to t′₀ 637 from the 20 ms of FIG. 5 to 30 ms. The duration of the reset potential difference, from t₁ 638 to t′₂ 640, is increased from 150 ms in FIG. 5 to 225 ms. The duration of the additional reset, from t′₂ 640 to t₂ 639, is increased from 50 ms to 75 ms. The duration of the picture potential difference, from t₃ 641 to t₄ 635 in FIG. 6, is also increased from the 50 ms value in FIG. 5 to 75 ms. The controller 15 transmits the series of pulses of potential difference shown in FIG. 6 to the display element to effect the change in optical state from light gray to dark gray.

While the above solution discusses the use of a single LUT as a basis for scaling, it is clearly possible that at extremes of temperature it may be necessary to generate one or more further LUT's to be used as the basis for scaling at these temperatures. A display requiring only 2 or 3 LUT's (instead of 45) also represents a major cost saving.

The waveforms typically include: reset voltage pulse(s) which bring the display to one of the extreme optical states, over-reset pulse(s) which , together with a reset pulse, present an energy more than sufficient to bring the display to one of the extreme optical states, driving pulse(s) which bring the display to a desired intermediate optical state, and shaking pulse(s) which present an energy sufficient to release charged particles from a present state but insufficient to move the particles from one of the extreme states to the other extreme state.

In a still further embodiment, it is noted that the only certain parts (over-reset, final grayscale drive part) of the complete drive-waveform (shake, over-reset, shake, grayscale drive) is most sensitive to temperature. In certain embodiments, only these portions may need to be accurately scaled in the LUT's.

The invention is applicable to both single and multiple window displays, where, for example, a typewriter mode exists. It must be emphasized that in the above examples, the pulse-width modulated (PWM) driving is used for illustrating the invention, i.e. the pulse time is varied in each waveform while the voltage amplitude is kept constant. This invention is also applicable to other driving schemes, e.g. based on the voltage modulated driving (VM) in which the pulse voltage amplitude is varied in each waveform, or combined PWM and VM driving. This invention is also applicable in color bi-stable displays and the electrode structure is not limited such as to top/bottom electrode structure or honeycomb structure or other; combined in-plane-switching and vertical switching may be used.

Finally, the above-discussion is intended to be merely illustrative of the present invention and should not be construed as limiting the appended claims to any particular embodiment or group of embodiments. For example, the controller 315 may be a dedicated processor for performing in accordance with the present invention or may be a general-purpose processor wherein only one of many functions operates for performing in accordance with the present invention. The processor may operate utilizing a program portion, multiple program segments, or may be a hardware device utilizing a dedicated or multi-purpose integrated circuit. Each of the systems utilized may also be utilized in conjunction with further systems. Thus, while the present invention has been described in particular detail with reference to specific exemplary embodiments thereof, it should also be appreciated that numerous modifications and changes may be made thereto without departing from the broader and intended spirit and scope of the invention as set forth in the claims that follow. The specification and drawings are accordingly to be regarded in an illustrative manner and are not intended to limit the scope of the appended claims.

In interpreting the appended claims, it should be understood that:
a) the word “comprising” does not exclude the presence of other elements or acts than those listed in a given claim;
b) the word “a” or “an” preceding an element does not exclude the presence of a plurality of such elements;
c) any reference numerals in the claims are for illustration purposes only and do not limit their protective scope;
d) several “means” may be represented by the same item or hardware or software implemented structure or function; and
e) each of the disclosed elements may be comprised of hardware portions (e.g., discrete electronic circuitry), software portions (e.g., computer programming), or any combination thereof.

1. A display (301) comprising:
a display element (118) including an electrophoretic medium, the electrophoretic medium comprising charged particles (108, 109) in a fluid (110);
a first electrode (105) and a second electrode (106) associated with the display element (118);
a drive means (210, 212, 215, 216) arranged to supply a sequence of potential differences to the display element (118);
a first memory (314) for receiving data representative of at least one reference sequence of potential differences, the at least one reference sequence being determined for transfer of image information to the display (301) at a reference temperature of the display (301);
a second memory (314) for receiving and storing a scaling factor representative of at least one temperature of the display (301); and
a controller (315),
the controller (315) being configured to receive a temperature reading representative of the at least one temperature of the display (301), retrieve the scaling factor from the second memory (314), retrieve the at least one reference sequence from the first memory (314), and apply the scaling factor to the at least one reference sequence to determine a scaled sequence of potential differences for said temperature reading,
the scaled sequence of potential differences being capable of being applied to the first electrode (105) and the second electrode (106) for a desired change in the optical state of the display element (118).

2. The display (301) of claim 1, wherein the first memory and the second memory are the same.

3. The display (301) of claim 1, wherein the scaling factor is applied to a portion of the at least one reference sequence to determine the scaled sequence.

4. The display (301) of claim 3, wherein the portion of the at least one reference sequence is a shaking pulse, reset pulse or driving pulse.

5. The display (301) of claim 1, wherein the first memory (314) stores data representative of a plurality of reference sequences, each said reference sequence being determined for transfer of image information to the display (301) at a corresponding reference temperature of the display (301).

6. The display (301) of claim 1, wherein the first memory (314) and the second memory (314) are within the controller (315).

7. The display (301) of claim 1, wherein the scaled sequence of potential differences comprises one or more reset pulses and a driving pulse.

8. The display (301) of claim 7, wherein the scaled sequence of potential differences further comprises at least one shaking pulse prior to one of the one or more reset pulses.

9. The display (301) of claim 8, wherein the scaled sequence of potential differences further comprises at least one shaking pulse prior to the driving pulse.

10. The display (301) of claim 7, wherein one of the one or more reset pulses comprises an over-reset pulse.

11. An apparatus comprising: a controller (315), a memory (314), a temperature sensor (325) and a display element (218),
the display element (218) being capable of changing from a first optical state to a second optical state by application of any of a plurality of sequences of one or more potential differences,
the temperature sensor sensing a measured temperature indicative of a temperature of the display element (218),
a look-up table being stored in the memory (314),
the look-up table containing data representative of one or more of said plurality of sequences usable at one or more reference temperatures,
a table of scaling factors being stored in the memory (314), each scaling factor being representative of a duration of all or part of at least one of said plurality of the sequences of potential differences and representative of at least one measurable temperature of the display element (218),
the controller receiving the measured temperature, reading from the table of scaling factors a scaling factor representative of a measurable temperature representative of the measured temperature, applying the scaling factor to data representative of one of said plurality of sequences usable at one of the one or more reference temperatures, to determine a sequence of potential differences capable of effecting a change of the display element (118) from the first optical state to the second optical state.

12. The apparatus of claim 11, wherein the memory (314) is within the controller (315).

13. The apparatus of claim 11, wherein the memory (314) comprises an external data storage device.

14. The apparatus of claim 11, wherein the sequence of potential differences capable of effecting a change of the display element (218) from the first optical state to the second optical state comprises one or more reset pulses and a driving pulse.

15. The apparatus of claim 14, wherein the scaled sequence of potential differences further comprises at least one shaking pulse prior to one of the one or more reset pulses.

16. The apparatus of claim 15, wherein the scaled sequence of potential differences further comprises at least one shaking pulse prior to the driving pulse.

17. The apparatus of claim 14, wherein one of the one or more reset pulses comprises an over-reset pulse.

18. A computer program product for displaying information on a display (301) having display elements (118) arranged in a plurality of rows and columns, the computer program product comprising: computer code devices configured to cause a
computer to change one or more of the display elements (118) from a first optical state to a second optical state by application of a sequence of one or more potential differences said sequence being determined by scaling a reference sequence stored in a memory (314) of the computer, the scaling being according to a measured temperature indicative of the temperature of the display (301).

19. A method for displaying information on a display element (118) of a display (301) comprising:
storing a look-up table containing data representing a waveform necessary to bring the display element (118) at a reference temperature to a desired optical state;
storing a value (433) of a scaling factor, the scaling factor representing a variation of the waveform, the variation being necessary at one or more measured temperatures;
obtaining a temperature measurement representative of a temperature of the display (301);
retrieving the scaling factor value (433) representing at least one of said measured temperatures representative of the temperature measurement;
applying the scaling factor value (433) to the waveform to create a desired waveform;
addressing the display element (118) with the desired waveform to bring the display element (118) to the desired optical state.

20. The method of claim 19, the desired waveform comprising one or more reset pulses and a driving pulse.

21. The method of claim 20, the desired waveform further comprising at least one shaking pulse prior to one of the one or more reset pulses.

22. The method of claim 21, the desired waveform further comprising at least one shaking pulse prior to the driving pulse.

23. The method of claim 20, one of the one or more reset pulses comprising an over-reset pulse.
